(19) United States
(12) Patent Application Publication
(10) Pub. No.: US 2009/0292434 A1
(43) Pub. Date: Nov. 26, 2009

(54) Method for Synchronising Components of a Motor Vehicle Brake System and Electronic Brake Control System

(76) Inventor: Markus Bläser, Selbach (DE)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 12/373,569

(22) PCT Filed: Jul. 13, 2007
(86) PCT No.: PCT/EP07/06256

§ 371 Date: Jan. 13, 2009

(30) Foreign Application Priority Data
Jul. 14, 2006 (DE) 102006032726.8

(51) Int. Cl. G06F 19/00; B60T 8/88

(52) U.S. Cl. 701/70

(57) ABSTRACT

The invention relates to a method for synchronising components of a motor vehicle brake system with an electronic main control device with a main timer associated therewith, at least one sub-control device, which is subordinate to the main control device, with a timer associated therewith, wherein the main control device communicates with the at least one sub-control device in cycles, wherein, furthermore, the main control device and the at least one sub-control device in each case increment a cycle counter associated therewith. In this connection the main control device sends synchronising data which comprise a value of the cycle counter of the main control device to the at least one sub-control device, and the at least one sub-control device receives these synchronising data and sets its cycle counter to the received value of the cycle counter of the main control device if the received value of the cycle counter of the main control device differs from the value of the cycle counter of the sub-control device.

### CROSS-REFERENCE TO RELATED APPLICATIONS

This application claims priority to International Patent Application No. PCT/EP2007/006256 filed Jul. 13, 2007, the disclosures of which are incorporated herein by reference in their entirety, and which claimed priority to German Patent Application No. 10 2006 032 726.8 filed Jul. 14, 2006, the disclosures of which are incorporated herein by reference in their entirety.

### BACKGROUND OF THE INVENTION

The invention relates to a method for synchronising components of a motor vehicle brake system with an electronic main control device with a main timer associated therewith, at least one sub-control device, which is subordinate to the main control device, with a timer associated therewith, wherein the main control device communicates with the at least one sub-control device in cycles, and wherein, furthermore, the main control device and the at least one sub-control device in each case increment a cycle counter associated therewith.

In modern vehicle systems, in particular in the case of brake systems, important control functions are increasingly being taken over by electronic devices. In this connection different electronic components such as, for example, sensors for detecting vehicle parameters and control elements as well as actuators co-operate. These co-operating components are in each case provided with clock generators (timers) which in most cases are of quartz-based construction. This makes the components relatively expensive to acquire. Moreover, undesirable delays in the control of brake system-linked driving assistance systems can occur due to different operating frequencies of the electronic components co-operating with one another. This is also undesirable, as vehicle assistance systems should intervene in the vehicle operation as far as possible without a time delay after detecting relevant vehicle parameters.

There is therefore a need for a method for synchronising electronic components of a motor vehicle brake system and for an electronic brake control system which functions reliably and permits the use of inexpensive components while avoiding the disadvantages described above.

### BRIEF SUMMARY OF THE INVENTION

The method initially mentioned is provided according to the invention for this purpose, wherein the main control device sends synchronising data which comprise a value of the cycle counter of the main control device to the at least one sub-control device, and the at least one sub-control device receives these synchronising data and sets its cycle counter to the received value of the cycle counter of the main control device if the received value of the cycle counter of the main control device differs from the value of the cycle counter of the sub-control device. It is thus possible to synchronise the main control device and the at least one sub-control device with little expenditure and a low data throughput.

By means of this synchronisation the at least one sub-control device can be adapted to the main control device with regard to its working cycle, so that time delays in the response of the vehicle brake system, for example in relation to an activation of a driving assistance program, can largely be minimised.

In one development of the invention, in the case in which the received value of the cycle counter of the main control device differs from the value of the cycle counter of the at least one sub-control device, the at least one sub-control device can generate an error signal, store this and/or send it to the main control device. The main control device can deduce or recognise from this error signal whether a more extensive error diagnosis with regard to the mode of operation of the sub-control device has to be carried out and optionally initiate this.

In one variant of the invention a clock cycle of the timer associated with the at least one sub-control device can be adjusted. The timer of the sub-control device can as a result—if necessary—be postsynchronised with regard to the timer of the main control device. In this connection it is in particular possible for the main control device to send control signals to the at least one sub-control device at regular time intervals of a predetermined length and for the at least one control device to detect the time interval between consecutive control signals and postsynchronise the timer associated therewith according to the detected time interval if the detected time interval differs from the time interval of a predetermined length. In this connection it is of advantage for the at least one sub-control device to reduce the clock cycle of the timer associated therewith if the detected time interval is greater than the time interval of a predetermined length; on the other hand the at least one sub-control device increases the clock cycle of the timer associated therewith if the detected time interval is smaller than the time interval of a predetermined length. A method of this kind makes additional ideal synchronisation possible if, with regard to a highly time-sensitive interaction of electronic components, there is an increased requirement for even more exact synchronisation which the method described above cannot satisfy alone.

In one preferred embodiment according to the invention the main control device and the at least one sub-control device communicate with one another via a bus system. This bus system is preferably a LIN bus system (LIN Local Interconnect Network) or a bus system which is based on a LIN bus. A bus system of this kind is widespread in vehicle technology and can be used inexpensively. When using a bus system it is in particular possible for the main control device to assign access rights to the bus to the at least one sub-control device. This means that the main control device is responsible for controlling communication and communication between the components can be carried out under controlled and accurately defined circumstances.

In one advantageous embodiment of the invention the main control device can send data to the at least one sub-control device, the data containing an identification symbol which identifies the sub-control unit to which the main control device has assigned write access rights and/or read access rights to the bus. The sub-control device in question is thereby informed of its access right status and can locally activate access to the bus. In this connection the main control device can in particular assign write access rights to the bus to just one sub-control device at any time. This prevents collisions in write access as well as data losses and delays when writing to the bus.

The main control device preferably assigns read access rights to the bus to a plurality of the at least one sub-control device and the main control device. This enables the bus bandwidth to be used efficiently and a plurality of control devices to read out information from the bus.

In one preferred embodiment the synchronising method according to the invention is applied in an electronic control system with at least two sub-control devices. In the case of certain applications in vehicle technology, for example in the case of EPB systems (Electronic Parking Brake system) it is desirable to provide two sub-control devices to activate rear wheel brake actuators, namely a separate sub-control device for each rear wheel for activating a respective parking brake actuator associated with the rear wheel. According to the invention, in this connection the main control device can be formed so that it sends synchronising data to a first of the sub-control devices when its cycle counter has an even value and synchronising data to a second of the sub-control devices when its cycle counter has an odd value. This results in a uniform distribution of the communication cycles.

The main timer of the main control device preferably comprises a quartz crystal. Crystals of this kind are known for their high accuracy and reliability and are therefore well suited as basic timers for synchronisation. The timer which is associated with the at least one sub-control device can comprise an RC circuit. RC circuits of this kind are favourable in terms of acquisition and their clock cycle can also easily be adjusted during operation. It is also possible for the at least one sub-control device to be formed as a sensor with a microcontroller device, for example as a yaw rate sensor.

As already indicated above, it is also possible for the at least one sub-control device to be associated with an actuator which is used in an EPB system, for example.

Within the scope of the invention the main control device which is used can be, for example, an ECU (Electronic Control Unit) which is designed such that the software for an EPB monitoring and control system runs thereon.

In one preferred development of the invention the main control device can send an error inquiry to the at least one sub-control device, whereupon the sub-control device sends the information concerning errors having occurred to the main control device in a diagnostic mode. It thus becomes possible to obtain a more accurate error diagnosis, with the possibility in particular of drawing conclusions as to the time stability of the timers of the sub-control device.

The present invention also relates to an electronic control system for a motor vehicle brake system with a main control device with a main timer associated therewith, at least one sub-control device, which is subordinate to the main control device, with a timer associated therewith, wherein the main control device communicates with the at least one sub-control device in cycles, and wherein, furthermore, the main control device and the at least one sub-control device in each case increment a cycle counter associated therewith, and the main control device and the at least one sub-control device are synchronised by a method as described above.

According to a further aspect of the invention, the object is achieved by a computer program product for executing the described method steps, wherein the computer program product runs on a processing unit.

Other advantages of this invention will become apparent to those skilled in the art from the following detailed description of the preferred embodiments, when read in light of the accompanying drawings.

### BRIEF DESCRIPTION OF THE DRAWINGS

FIG. 1 represents an electronic control system according to the invention;

FIG. 2 represents a flow diagram of a main loop of a sub-control device;

FIG. 3 represents a flow diagram for a clock cycle adjustment of the timer of a sub-control device;

FIG. 4 represents the time flow of a signal sequence;

FIG. 5 represents an example of synchronisation.

### DETAILED DESCRIPTION OF THE INVENTION

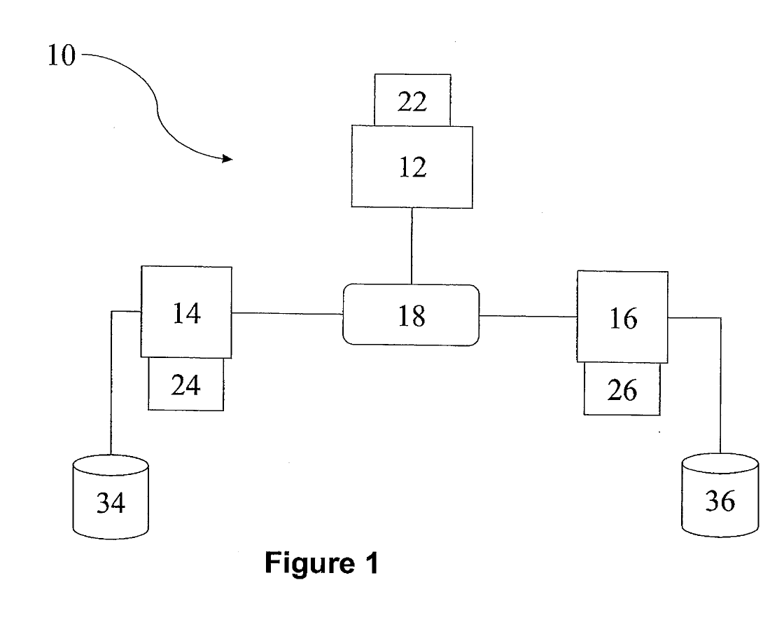

An embodiment of the invention is represented in greater detail in the following on the basis of the figures. In the embodiment which is represented in FIG. 1 the electronic components are part of an EPB (Electronic Parking Brake) 10. The EPB system 10 comprises a main control device 12 with a main timer 22 associated therewith. The EPB system 10 also comprises the sub-control devices 14 and 16, which each have a timer 24 and 26, respectively. The main timer 22 has a quartz crystal and clocks at a clock frequency of 4 MHz. The timers 24, 26 have adjustable RC elements for predetermining a clock frequency of likewise 4 MHz.

In addition, the main control device 12 communicates via a separate connection (not shown), for example a CAN bus, with other components of the vehicle electronics and can, for example, route error signals delivered by the sub-control devices 14, 16 to a main processor (also not shown).

The sub-control devices 14 and 16 are in each case connected to actuators 34, 36 of the EPB system 10 and activate these. In this case the actuator 34 is fitted to the left-hand rear wheel and the actuator 36 to the right-hand rear wheel of a motor vehicle and these are provided to activate or deactivate the parking brake function. Therefore the sub-control device 14 is also called the left-hand sub-control device 14 and the sub-control device 16 the right-hand sub-control device. The actuators 34, 36 generate a parking brake force which is controlled by the sub-control devices 14, 16 and acts on the rear wheels.

The control devices 12, 14 and 16 communicate with one another via a bus system 18. In the embodiment under consideration this bus system is in the form of a LIN bus system. LIN bus stands for Local Interconnect Network bus and follows the LIN protocol. This protocol was developed for inexpensive communication for intelligent sensors and actuators in motor vehicles.

A LIN network comprises a LIN master, in this case the main control device 12, and one or a plurality of LIN slave(s), in this case the sub-control devices 14 and 16. The main control device 12 controls the time flow of the data which are to be transmitted. Here the sub-control devices 14, 16 only transmit data when they are requested or authorised to do so by the main control device 12.

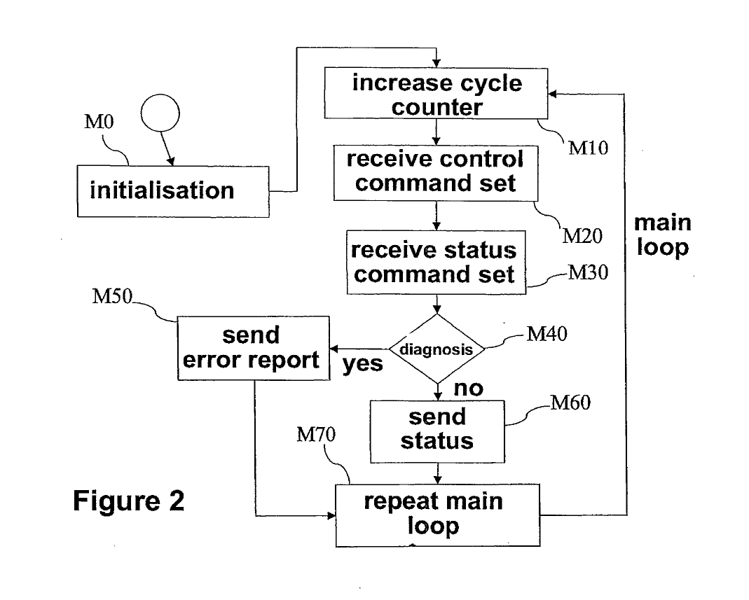

FIG. 2 shows a flow diagram of the main loop through which the sub-control devices 14, 16 run. Only working steps which are linked with the communication and synchronisation of the control devices 12, 14, 16 are represented here; processes which are linked with activation of the actuators 34, 36 through the sub-control devices 14, 16 are not shown.

Following a start a sub-control device 14, 16 is initialised in the step M0. This step can comprise, inter alia, the writing of registers, checking the operational capability of the sub-control device 14, 16 and of the bus 18.

Afterwards the sub-control device 14, 16 starts, with the step M10, running through a cycle of its main loop. In this step the sub-control device 14, 16 increments the value of its cycle counter.

In the case of the LIN bus only 4 bits are available for the transmission of the counter, for which reason the counter can accept values from 0 to 15 and is reset from 15 upon a further increase to zero. Therefore, within the overall scope of this description, an increase in the value of the cycle counter also means that a threshold value of the cycle counter is reached and the cycle counter is reset to zero; this also applies to possible embodiments other than that described here. In this respect the threshold value can depend on the number of bits provided for a cycle counter transmission.

In the step M20 the sub-control device 14, 16 receives a control command set from the main control device 12. The sub-control device 14, 16 can activate the actuator 34, 36, for example, according to these commands. The control command set comprises, inter alia, the value of the cycle counter of the main control device 12.

Afterwards the sub-control device 14, 16 receives a status command set from the main control device 12 in the step M30. In this status command set the main control device 12 can inquire about the status of the sub-control device 14, 16 or about a diagnosis status, for example. The status command set contains an identification symbol which accords one of the sub-control devices 14, 16 write access rights to the bus 18.

Should the main control device request a diagnosis, branching to a diagnostic mode takes place in the step M40. In the step M40 the sub-control device 14, 16 authorised to write to the bus 18 then transmits stored error values to the main control device 12. After M40 the step M60 is executed and the main loop run through once again.

If the main control device does not request a diagnosis, branching to step M50 takes place in step M40. In this step the sub-control device 14, 16 authorised to write to the bus 18 sends a status report to the main control device 12. This status report contains, inter alia, information on the status of the actuator 34, 36 associated with the sub-control device 14, 16. A transition to step M60 also takes place after M50.

Step M60 results in a new cycle of the main loop being run through, beginning at M10. The main loop of the sub-control device 14, 16 therefore essentially comprises the steps M10 to M60 and is in each case run through in cycles lasting 20 ms.

After each of the steps of the main loop it is possible to insert one or more step(s) in which cycle counter synchronisation takes place. Here the value of the cycle counter received from the main control device 12 is compared with the value of the cycle counter of the sub-control device 14, 16. If these values differ from one another, the sub-control device 14, 16 sets its cycle counter to the value received from the main control device 12. If the values are equal, no cycle counter synchronisation is required. In the embodiment described here the sub-control device 14, 16 generates and stores an error signal following synchronisation of its cycle counter. This synchronisation can be carried out as a further step between the steps M20 and M30, for example, while the sub-control device 14, 16 is not occupied with bus access.

The main control device 12 likewise runs through a main loop of 20 ms duration, whose steps which are run through are at least partly complementary to those of the main loop of the respective sub-control device 14, 16. Dependent upon the precise use of a system described here, it may be necessary to execute further sub-processes in addition to the diagnostic report and the status report in branches of the main loop.

The LIN bus system has a data transfer rate of approximately 20 kbit/s maximum (only 8 bytes being provided for the useful data in a packet sent by a sub-control device). Therefore the main control loop of the main control device 12 cannot respond to both sub-control devices 14, 16 within a main loop cycle in this embodiment. For this reason the main control device 12 responds alternately to the sub-control devices 14, 16, running through a main loop cycle in the case of an even cycle counter count, in which it communicates with the right-hand sub-control device 16, and communicating with the left-hand sub-control device 14 in the case of an odd cycle counter count. It is of course also possible to use another distribution mode for the communication cycles, according to the requirements of the respective application, in other embodiments.

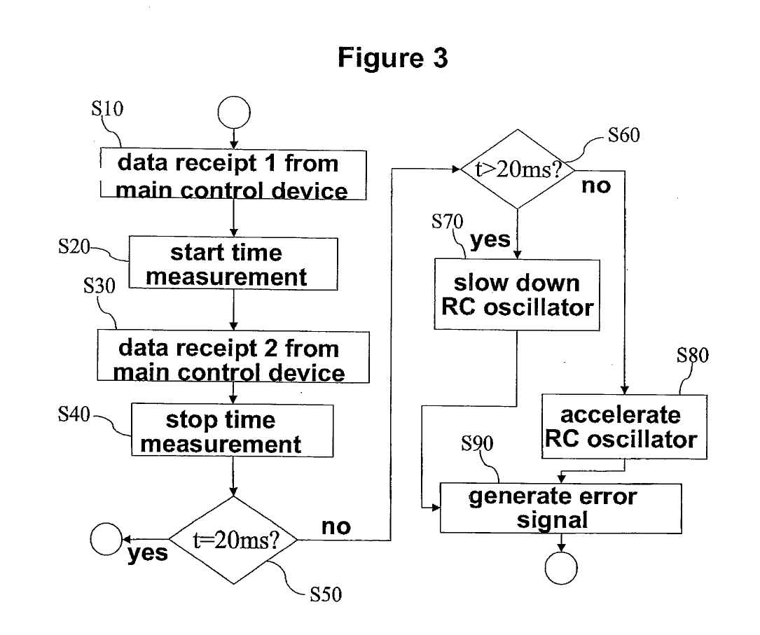

FIG. 3 shows a flow diagram for adjusting the clock cycle of the timer of one of the sub-control devices 14, 16.

Here a first data packet with control signals is received from the main control device 12 (abbreviated to HS in the figures) in a first step S10. These control signals signal to the sub-control device 14, 16 to initiate the step S20, with which time measurement up to the receipt of a new control signal from the main control device 12 is begun.

As soon as a second data packet with control signals has been received from the main control device 12 in a step S30, the time measurement is stopped in a step S40. A value t for the lapsed time between the receipt of the two data packets sent by the main control device 12 is then detected.

In a step S50 a check is carried out as to whether this time t, which the sub-control device 14, 16 has detected, corresponds with a predetermined interval of 20 ms which is established between the sending of the two data packets with control signals by the main control device 12. It is of course possible to apply any other suitable value for the time interval instead of 20 ms; where the device of a system is concerned, care must be taken to ensure that both the sub-control device 14, 16 and the main control device 12 use the same predetermined value.

If the value t corresponds to a time of 20 ms, no postsynchronisation by changing the clock frequency of the RC oscillator of the timer 24, 26 of the sub-control device 14, 16 is necessary and the synchronisation procedure is terminated.

Should t not be equal to 20 ms, a check is carried out in a next step S60 as to whether the detected time t is greater than 20 ms. If this is the case, the RC oscillator of the sub-control device 14 has clocked too quickly and is slowed down in a step S70. Afterwards the step S90 described in the following can be executed or the clock cycle adjustment procedure is terminated. If, however, the detected time interval t is less than 20 ms, the clock frequency of the RC oscillator is too low and the clock frequency of the RC oscillator is increased in a step S80. It is also possible after this step to execute the step S90, which generates an error signal which establishes that there is a clock cycle error or the clock cycle adjustment procedure is terminated. The clock cycle adjustment process is terminated after the step S90.

Ideal synchronisation of this kind through clock cycle adjustment can be initiated, for example, by branching in the main loop of the main control device 12. The main control device 12 can then send a signal to the sub-control device 14, 16 which indicates that ideal synchronisation is being carried out. The main control device 12 and the sub-control device 14, 16 thereupon change to ideal sychronisation mode.

However it is also possible to carry out ideal synchronisation without special initiation by the main control device 12: In each cycle of its main loop the main control device 12 sends via the bus a data set which can be read out by both sub-control devices 14, 16, even if only one sub-control device 14, 16 can ever respond on account of the alternating addressing. Therefore signals of the main control device 12 are available every 20 ms, according to which signals the sub-control devices 14, 16 can synchronise their timers. It is in addition possible, for example, to insert a further step, which starts or terminates a time measurement in a cyclic, alternating manner, between the steps M10 and M20 in the main loop in FIG. 2. It is also possible to provide a further step between the steps M20 and M30 which provides for branching into a process similarly to steps S50 to S90 as described above.

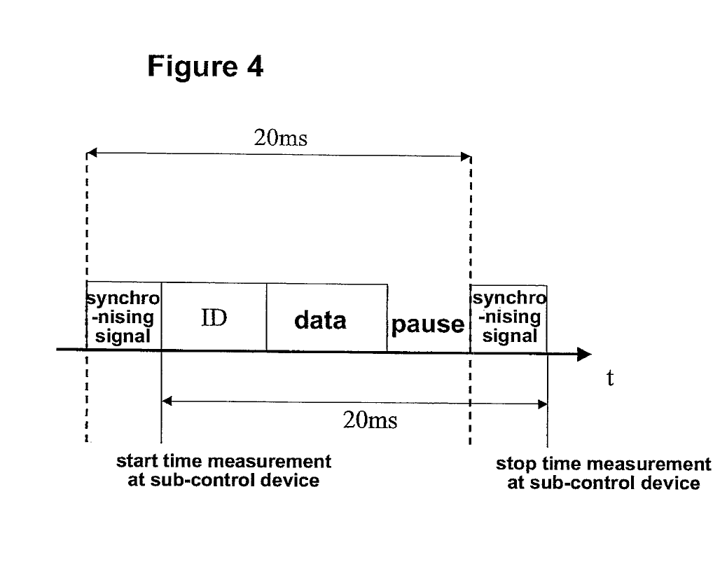

FIG. 4 represents a diagram for illustrating the ideal synchronisation procedure which is shown in FIG. 3. The time flow of the data exchange between the sub-control device 14, 16 and the main control device 12 is represented here in a simplified form.

A communication cycle lasting 20 ms takes place between the broken lines. The main control device 12 sends a control signal (synchronising signal) which is used to synchronise the sub-control device 14, 16, abbreviated to US in the drawing. Upon arrival of the synchronising signal the sub-control device 14, 16 starts a time measurement using the timer 24, 26 associated therewith. The main control device 12 subsequently sends to the sub-control device 14, 16 a data packet which contains an identification symbol ID and an inquiry, normally a status inquiry. The sub-control device 14, 16 responds to this, for example according to step M50. No further signals are exchanged between the main control device 12 and the sub-control device 14, 16 until the end of this cycle of the main loop, which is marked by the right-hand broken line in FIG. 4.

A new cycle of the main loop of the main control device 12 begins when a further synchronising signal is sent. The sub-control device 14, 16 terminates the time measurement upon receipt of this further synchronising signal or control signal. 20 ms should have been measured by the sub-control device 14, 16 between the receipt of the two synchronising signals; if this is not the case, the clock cycle of the timer 24, 26 is synchronised as described above.

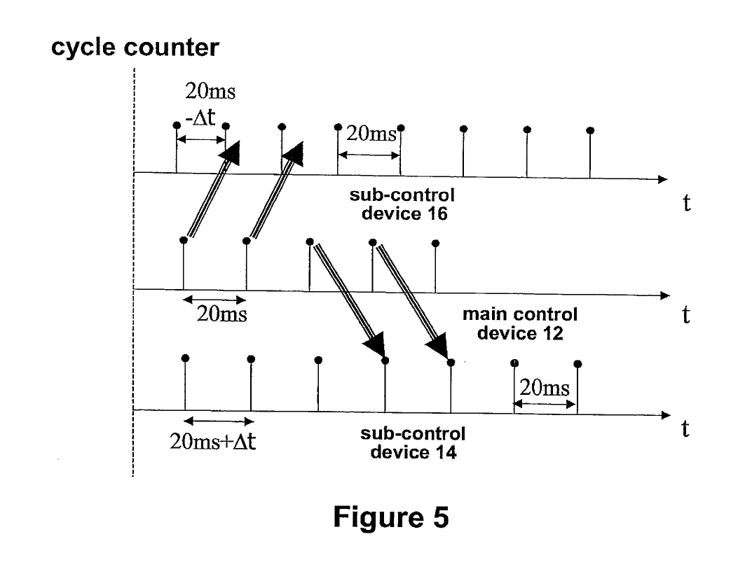

FIG. 5 represents synchronisation between the main control device 12 and the sub-control devices 14, 16 according to the method which is shown in FIGS. 3 and 4. The main control device generates cycles of a duration of 20 ms, the time interval of which is very stable on account of the high-quality quartz crystal in the main timer 24. In the example which is shown in FIG. 5 the timing of the sub-control device 16 is initially too fast; the cycles through which it runs have a time interval of less than 20 ms (20 ms−Δt). However the timing of the sub-control device 14 is in the beginning too slow; in the case of the latter 20 ms+Δt lapse between two cycles. The arrows in FIG. 5 represent the receipt of control signals for adjusting the clock cycle from the main control device 12 to the sub-control device 16 or the sub-control device 14. After a sub-control device 14, 16 has in each case received two consecutive control signals of this kind, synchronisation is carried out according to the steps S50 to S90. As a result, after synchronisation of this kind, the cycles are run through at an interval of 20 ms both in the case of the sub-control device 16 and in the case of the sub-control device 14. The cycle counter synchronisation as described above is not taken into account in this FIG. 5.

Synchronisation as presented in this description can of course be carried out with a plurality of different electronic components.

In this respect the method according to the invention has particularly advantageous effects in that rapid and reliable synchronisation is possible without this requiring a large number of expensive timers. The method according to the invention can also be applied to components of an electronic brake system with any desired timers.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. Method for synchronising components of a motor vehicle brake system comprising the following steps:
(a) providing an electronic main control device with a main timer associated therewith, and at least one sub-control device, which is subordinate to the main control device, with a sub-control device timer associated therewith, with the main control device communicating with the at least one sub-control device in cycles, and wherein, furthermore, the main control device and the at least one sub-control device in each case increment a cycle counter associated therewith;
b) the main control device sending synchronising data which comprise a value of the cycle counter of the main control device to the at least one sub-control device; and
(c) the at least one sub-control device receives these synchronising data and sets its cycle counter to the received value of the cycle counter of the main control device if the received value of the cycle counter of the main control device differs from the value of the cycle counter of the sub-control device.

2. Method according to claim 1, wherein the sub-control device also generates an error signal if the received value of the cycle counter of the main control device differs from the value of the cycle counter of the sub-control device.

3. Method according to claim 2, wherein the generated error signal is stored by the sub-control device.

4. Method according to claim 1, wherein a clock cycle of the timer associated with the at least one sub-control device can be adjusted.

5. Method according to claim 4, wherein the main control device sends control signals to the at least one sub-control device at regular time intervals of a predetermined length and the at least one sub-control device detects the time interval between consecutive control signals and postsynchronises the timer associated therewith according to the detected time interval if the detected time interval differs from the time interval of a predetermined length.

6. Method according to claim 5, wherein the at least one sub-control device reduces the clock cycle of the timer associated therewith if the detected time interval is greater than the time interval of a predetermined length.

7. Method according to claim 5, wherein the at least one sub-control device increases the clock cycle of the timer associated therewith if the detected time interval is smaller than the time interval of a predetermined length.

8. Method according to claim 5, wherein the main control device and the at least one sub-control device communicate with one another via a bus system.

9. Method according to claim 8, wherein the bus system is a LIN bus system or LIN-based bus system.

10. Method according to claim 8, wherein the main control device assigns access rights to the bus to the at least one subordinate control device.

11. Method according to claim 10, wherein the main control device sends data to the at least one sub-control device, which data contain an identification symbol which identifies the at least one sub-control unit to which the main control device assigns at least one of write access rights and read access rights to the bus.

12. Method according to claim 11, wherein the main control device always assigns write access rights to the bus to just one of the at least one sub-control device.

13. Method according to claim 11, wherein the main control device assigns read access rights to the bus to at least one of a plurality of the at least one sub-control device.

14. Method according to claim 1, wherein the components of the motor vehicle brake system comprise at least two sub-control devices.

15. Method according to claim 14, wherein the main control device sends synchronising data to a first of the sub-control devices when its cycle counter has an even value and synchronising data to a second of the sub-control devices when its cycle counter has an odd value.

16. Method according to claim 1, wherein the main timer comprises a quartz crystal.

17. Method according to claim 1, wherein the timer which is associated with the at least one sub-control device comprises an RC circuit.

18. Method according to claim 1, wherein the at least one sub-control device is formed as a sensor with a microcontroller device.

19. Method according to claim 1, wherein the at least one sub-control device is associated with an actuator of an electronic parking brake system.

20. Method according to claim 2, wherein the at least one sub-control device sends error information to the main control device in a diagnostic mode.

21. Electronic brake control system for a motor vehicle brake system comprising:
an electronic main control device with a main timer and a main cycle counter associated therewith;
at least one sub-control device, which is subordinate to the main control device, with a timer and a cycle counter associated therewith, the main control device communicating with the at least one sub-control device in cycles and the main control device and with the at least one sub-control device being synchronised by a method that includes the main control device sending synchronising data which comprise a value of the cycle counter associated with the main control device to the at least one sub-control device and with the at least one sub-control device receiving these synchronising data and setting its cycle counter to the received value of the cycle counter of the main control device if the received value of the cycle counter of the main control device differs from the value of the cycle counter of the sub-control device.

22. The method according to claim 1 further including a computer program product with program code means for carrying out the method for synchronising components when the computer program product runs on a processing unit associated with the motor vehicle.
